(19) United States
(12) Patent Application Publication
(10) Pub. No.: US 2012/0011573 A1
(43) Pub. Date: Jan. 12, 2012

(54) SYSTEM AND METHOD FOR MANAGING INSIDER SECURITY THREATS

(76) Inventors: Daniel A. MENASCE, Cabin John, MD (US); Ghassan Y. Jabbour, Fredericksburg, VA (US)

(21) Appl. No.: 13/180,151

(22) Filed: Jul. 11, 2011

Related U.S. Application Data
(60) Provisional application No. 61/363,458, filed on Jul. 12, 2010.

(51) Int. Cl. G06F 15/16

(52) U.S. Cl. 726/4

(57) ABSTRACT

A defense mechanism module is provided for protecting a system from a privileged user. In some embodiments, a defense mechanism module can be integrated with the system such that all communications between the privileged user and the system first communicate with the defense mechanism module.

### CROSS REFERENCE TO RELATED APPLICATIONS

This application claims priority from U.S. provisional patent application 61/363,458, filed on Jul. 12, 2010, the entirety of which is incorporated by reference.

### BRIEF DESCRIPTION OF THE DRAWINGS

FIG. 1 illustrates a system for managing insider threats in a database environment, according to one embodiment of the invention.

FIG. 2 illustrates a classification of users, according to one embodiment of the invention.

FIG. 3 illustrates a method for managing insider threats, according to one embodiment of the invention.

FIG. 4 illustrates a system for managing insider threats in an operating system environment, according to one embodiment of the invention.

FIG. 5 illustrates a system for managing insider threats in a network environment, according to one embodiment of the invention.

### DETAILED DESCRIPTION OF EMBODIMENTS OF THE INVENTION

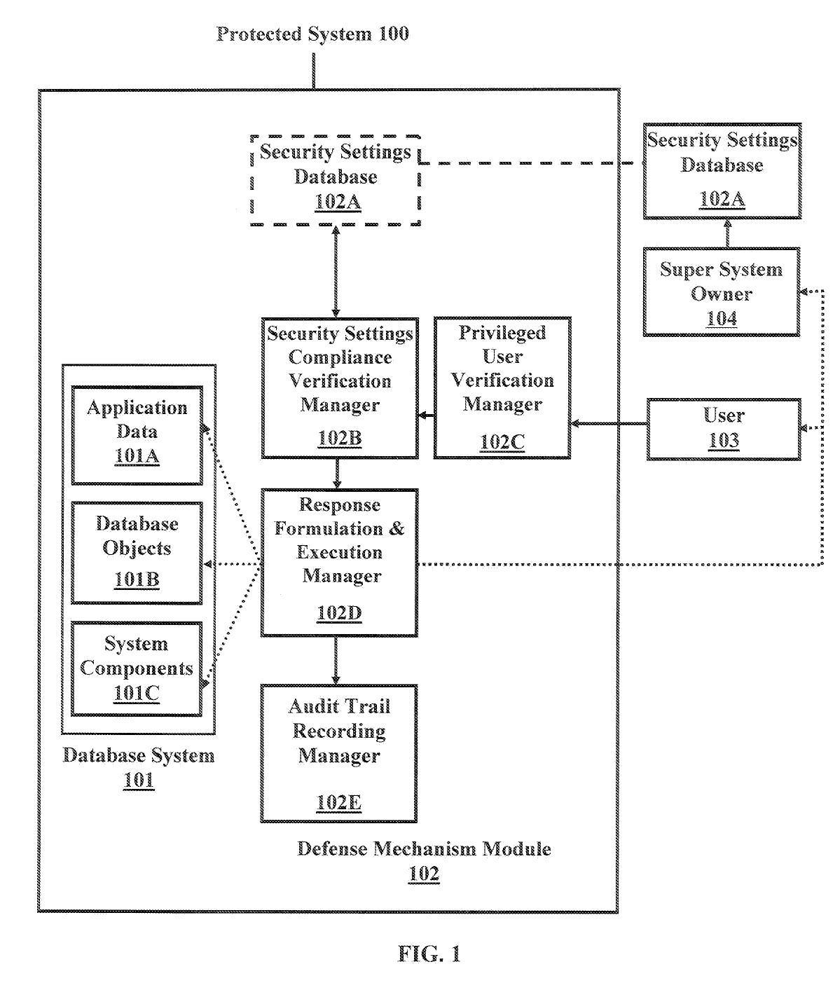

FIGS. 1-5 illustrate systems and methods for managing actions of privileged users, according to several embodiments of the invention. Applicant notes that the term “approved security settings” is used throughout this application and is synonymous with the term “security policy.” FIG. 1 illustrates a system for managing insider security threats in a database environment, according to one embodiment of the invention. Applicant notes that other embodiments are also possible, such as, but not limited to, an application embodiment (e.g., a computer application or a mobile computer application), an operating system embodiment, and a network embodiment.

Referring to FIG. 1, a protected system 100 can comprise a database system 101 and a defense mechanism module 102 that can be totally integrated into the core components of database system 101 such that all communications between a privileged user and the protected system 100 must go through the defense mechanism module 102. In this way, defense mechanism module 102 can help ensure a solid mitigation to the threat by a privileged user, and can help manage an affordable and assured compliance with system security requirements and government mandated regulations.

Database system 101 can comprise application data 101A, database objects 101B, and system components 101C. Application data 101A can comprise data about the domain that the application supports as well as metadata, which can be data that describes the data structure that the application hosts. Database objects 101B can comprise database tables, indexes, and database schemas. System components 101C can comprise objects (such as tables, views, logic) that can be owned by the database management system supporting the application installed on the system. Defense mechanism module 102 can comprise a security settings database 102A, a security settings compliance verification manager 102B, a privileged user verification manager 102C, a response formulation and execution manager 102D, and an audit trail recording manager 102E. Security settings database 102A can store approved security settings that can be created, maintained, and collectively owned by a Super System Owner (SSO) 104. Security settings database 102A may or may not reside inside protected system 100 as indicated by the dotted security settings database 102A box in FIG. 1. Privileged user verification manager 102C can determine whether the request was made from a privileged user. If the request was made from a privileged user, the request can include access requests to protected system 100 for performing system administration actions such as system configuration, performance tuning and optimization actions, installation of security patches, as well as other administrative actions on protected system 100, as will be recognized by the person having ordinary skill in the art. Security settings compliance verification manager 102B can consult with security settings database 102A to determine whether a request complies with the approved security settings. Response formulation and execution manager 102D can formulate appropriate response(s) to a request based on the outcome of the consultation with security settings database 102A and is able to execute the response in order to protect protected system 100. Audit trail recording manager 102E can record all requests submitted to protected system 100 and the response by the system to each request. This information can be used as actionable information by protected system 100, more specifically by its defense mechanism components, to respond to future requests and to discover patterns related to requests by insiders.

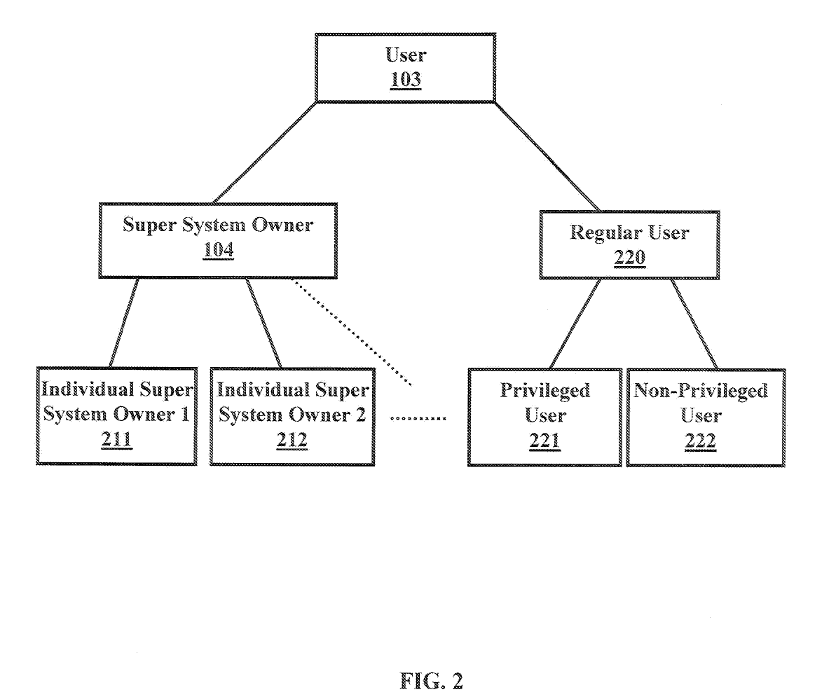

FIG. 2 provides a classification of users which can be employed in some embodiments. A user 103 can comprise a Super System Owner (SSO) 104 and/or a regular user 220. In one embodiment, SSO 104 can comprise at least two individuals and/or entities. In other embodiments, SSO 104 can comprise one individual and/or entity. Regular user 220 can comprise a privileged user 221 and/or a non-privileged user 222. A privileged user 221 can refer to any insider who has a privileged access to a system that can be owned by the organization that the user works for. An example of such a privileged user can include a database administrator, an operating system administrator, or a network administrator. In a traditional database management system environment, such as Oracle Database Management System, IBM DB2, or Microsoft SQL Server, the database administrator can be a person who has the power to manipulate every aspect of the database and can therefore intentionally or unintentionally compromise the security posture of the database. In the context of this first embodiment of the invention, which can be a database management system, the database administrator cannot change the security settings of the database, but must direct such a request to SSO 104, where SSO 104 can be comprised of at least two individuals. In some embodiments, the database administrator cannot alone change the security settings of the database, but must receive permission from SSO 104, where the SSO can comprise two or more individuals.

Referring again to FIG. 1, privileged user verification manager 102C can receive a request from a user 103. The request, for example, can be to change or modify certain database objects or parameters, or to view data contained in database system 101. The request may come from privileged user 221, non-privileged user 222, or SSO 104, or any combination thereof After determining that the request was from privileged user 221, privileged user verification manager 102C passes the request to security settings compliance verification manager 102B. Security settings compliance verification manager 102B queries the security settings database 102A to determine if the request is permitted by the security policy. If the request is allowed, response formulation and execution manager 102D can build a proper response (in the form of database commands) and executes it against the affected components of protected system 100. In addition, privileged user 221 can be notified of the outcome of processing the request and audit trail recording manager 102E can be updated to record the transaction. On the other hand, if the request is not allowed, the response formulation and execution manager 102D can build a proper response (in the form of database commands) for that situation (which can be basically a rejection of the request) and relay it to the requestor, which can be privileged user 221. Furthermore, response formulation and execution manager 102D can send a message alerting SSO 104 of the failed attempt and update audit trail recording manager 102E to record the transaction.

SSO 104 can configure the security settings of security settings database 102A with security settings that support certain business objectives and comply with certain security guidelines, such as, but not limited to Federal Information Systems Management Act (FISMA) of 2002, OMB Circular A-1123, NIST Special Publications (such as SP 800-53), and others. The database parameter settings as recommended by these organizations can be for the most part static, meaning that they rarely have to be changed. For example, setting a database parameter that enforces the life time of a password to be only 60 days does not have to be changed often.

However, in one embodiment where security settings have to be changed, SSO 104 can make that change. The following criteria can be satisfied by SSO 104. First, SSO 104 can be made up of at least two independent individuals with each individual owning a partial password of the complete password that gives access to security settings database 102A. A complete and valid password can be formed when all the partial passwords are concatenated in the proper order. This can ensure that no individual Super System Owner can modify the security settings alone. Second, the individuals that make up SSO 104 can be other than database, system, or network administrators, and they do not have access to protected system 100, but only to security settings database 102A.

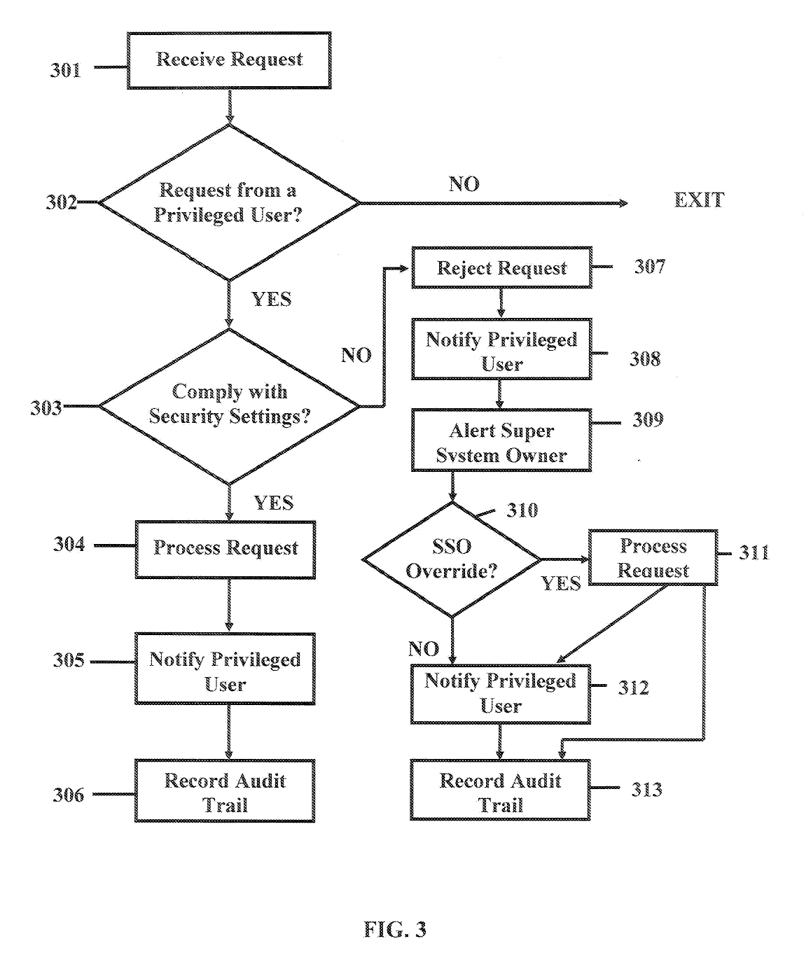

FIG. 3 illustrates a method for managing insider security threats, according to one embodiment of the invention. In 301, a request can be ,received from user 103. In 302, privileged user verification manager 102C can determine whether the received request was from a privileged user. If no, the request is not from a privileged user, defense mechanism module 102 does not need to proceed further. If yes, the request is from a privileged user, security settings compliance verification manager 102B can determine whether the request complies with approved security settings (action 303). If yes, the request complies with the approved security settings, and the security settings compliance verification manager 102B can allow the request to be processed in database system 101 (action 304). In addition, response formulation and execution manager 102D may notify the privileged user of the status of the request (action 305), and actions can be recorded by audit trail recording manager 102E (action 306). When the request does not comply with the approved security settings, the security settings compliance verification manager 102E can reject the request (action 307). Further, response formulation and execution manager 102D can notify the privileged user of the status of the request and alert SSO 104 (action 308, 309). Security settings verification manager 102B can also determine whether SSO 104 overrides and thus approves the request. If SSO 104 chooses to allow the operation (action 310) by modifying the security settings, then the request can be processed (action 311) and the audit trail can be updated by audit trail recording manager 102 (action 313). Otherwise, the privileged user can be notified (action 312) of the failure of the request, and the audit trail can be updated by audit trail recording manager 102E (action 313).

An example of a database embodiment follows. A database that has been configured to comply with strict security settings would allow a user to attempt to login in to the database for at most, for example, three times, before the user gets locked out. In such situation, if the user uses a wrong username or password three times in a row, then the database would lock the user out and the user will not be able to login again until a database administrator uses his/her rights to unlock the user account and probably reset the password. If a database administrator can change the security settings to make the unlimited login process possible, this can allow hackers to keep trying until they get in. When the database administrator issues a request to alter the failed login attempts parameter to unlimited numbers, the request can be determined to come from a privileged user (action 302) because the database administrator can be one of privileged users. Then, security settings compliance verification manager 102B will determine whether the request is allowed by consulting with security settings database 102A which stores information as to whether the database administrator can change the number of failed login attempts parameter (action 303). If the request is allowed, the request to alter the failed login attempts parameter will be processed in database system 101. In addition, response formulation and execution manager 102D may notify the database administrator of the status of the request (action 305), and actions can be recorded by audit trail recoding manager 102E (action 306). If the request is not allowed, the request can be rejected by security settings compliance verification manager 102B as not complying with security settings (action 307). Further, response formulation and execution manager 102D may notify the privileged user of the status of the request and alert SSO 104 (action 308, 309). Security settings verification manager 102B can also determine whether SSO 104 overrides and thus approves the request. When the request includes an SSO override request, security settings stored in security settings database 102A in FIG. 1 can be updated permanently or temporarily (e.g., one time only) (action 311), and actions can be recorded in audit trail by audit trail recording manager 102E (action 313). When SSO does not override and thus grant the request, response formulation and execution manager 102D can notify the database administrator of the status of the request (action 312), and record actions in audit trail by audit trail recording manager 102E (action 313).

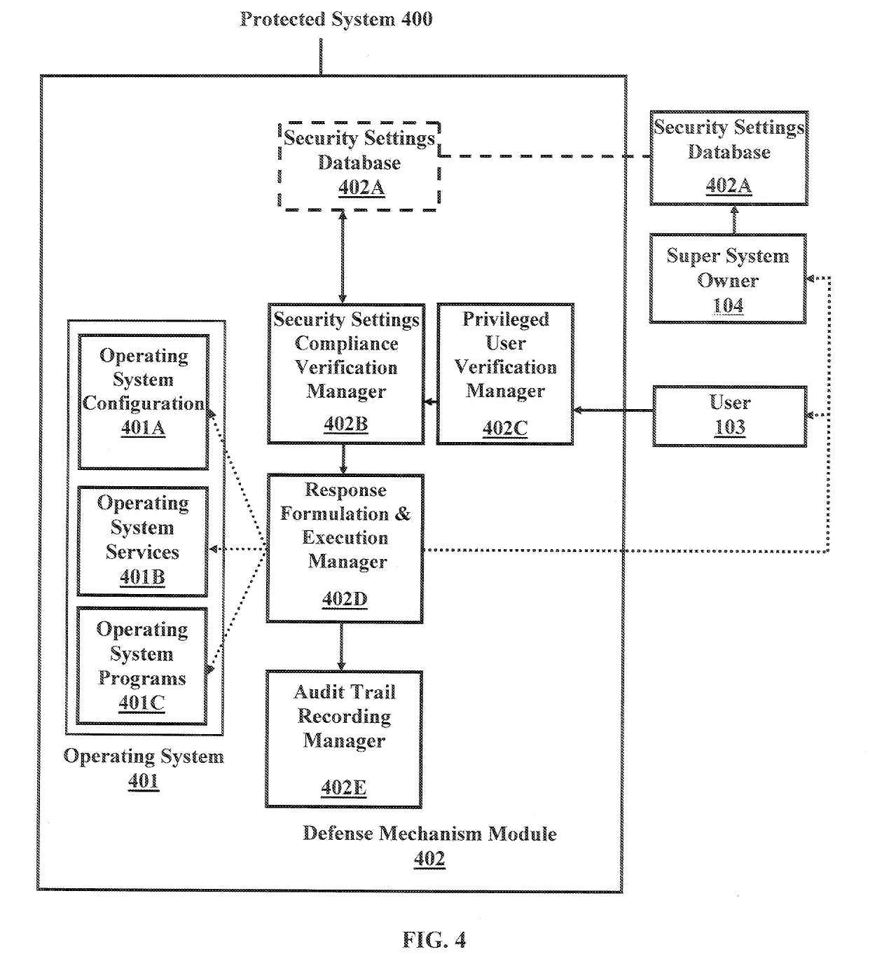

FIG. 4 illustrates a system for managing insider security threats in an operating system environment, according to another embodiment of the invention. A protected system 400 can comprise an operating system 401, and a defense mechanism module 402 that can be totally integrated into the core components of operating system 401.

Operating system 401 can comprise operating system configurations 401A, operating system services 401B, and operating system programs 401C. Operating system configurations 401A can be actual configurations that have been put in place by SSO 104 to properly configure and secure the computer that an operating system can be installed on. Examples of operating system configurations 401A can include stopping and starting program services, adding privileged users, or changing password strength levels, etc., or any combination thereof. Operating system services 401B can be system services that allow their respective programs to run on the computer on which they are installed. Operating system programs 401C can be the programs that are actually installed on a computer to protect it against various dangers. Examples of such programs can include antivirus programs and/or encryption programs, etc.

Defense mechanism module 402 can comprise a security settings database 402A, a security settings compliance verification manager 402B, a privileged user verification manager 402C, response formulation and execution manager 402D, and an audit trail recording manager 402E. The security settings database 402A can have the same functionality as the security settings database 102A in FIG. 1 and may or may not reside inside protected system 400 thus its depiction as a dotted box inside in FIG. 4. The security settings can be parameters that have been entered into security settings database 402A by SSO 104 to support certain business objectives and comply with certain security guidelines, such as, but not limited to Federal Information Systems Management Act (FISMA) of 2002, OMB Circular A-1123, NIST Special Publications (such as SP 800-53), and others. The security parameter settings as recommended by these organizations can be for the most part static, meaning that they rarely have to be changed. Security settings database 402A can store approved security settings that can be created, maintained, and collectively owned by SSS 104. Security settings compliance verification manager 402B can consult with security settings database 402A to determine whether a request from a system administrator complies with the approved security settings. Privileged user verification manager 402C can determine whether the request was made from a privileged user. Response formulation and execution manager 402D can formulate the appropriate response based on the outcome of the consultation with the security settings database 402A and is able to execute the response in order to protect protected system 400. Audit trail recording manager 402E can record all requests submitted to the system and the response by the system to each request. This information can be used as actionable information by protected system 400, more specifically by its defense mechanism components, to respond to future requests and to discover patterns related to requests by insiders.

An example of an operating system embodiment follows. A system administrator can have the power to change every single configuration parameter of the operating system, including the power to give the role of administrators to others. Personal computers or laptops in an organizational setting, or a data center setting, can be normally set up in a way that the user whose laptop or personal computer is assigned is a regular user with limited rights to affect the configuration of the computer. To be more specific, regular users may not be allowed to install software on the computers that are assigned to them by their company, or may not stop and start program services, etc. Defense mechanism 402 in FIG. 4 can be used if the system administrator tries to give administrator's rights to certain regular users who should not have these rights.

An example operation will be described by way of the flow chart in FIG. 3. Suppose that a system administrator issues a request to give privileged access to certain regular user. The request can be determined to come from a privileged user (action 302) because the system administrator can be one of privileged users. Security settings compliance verification manager 402B can determine whether the request is allowed by consulting with security settings database 402A which can store a list of regular users to whom privileged access could be given (action 303). If the request complies with the approved security settings as reflected by the security settings database 402A, the request can be processed (action 304), the privileged user can be notified (action 305), and an audit trail can be updated by audit trail recording manager 402E (action 306). If the request does not comply with the approved security settings as reflected by the security settings database 402A, the request can be rejected (action 307), the privileged user can be notified (action 308), and SSO 104 can be alerted (action 309). The security settings verification manager 402B can also determine whether SSO 104 overrides and thus approves the request (action 310). If SSO 104 chooses to allow the operation by modifying the security settings, then the request can be processed (action 311) and an audit trail can be updated by audit trail recording manager 402E (action 313). Otherwise, the privileged user can be notified (action 312), and an audit trail can be updated by audit trail recording manager 402E (action 313).

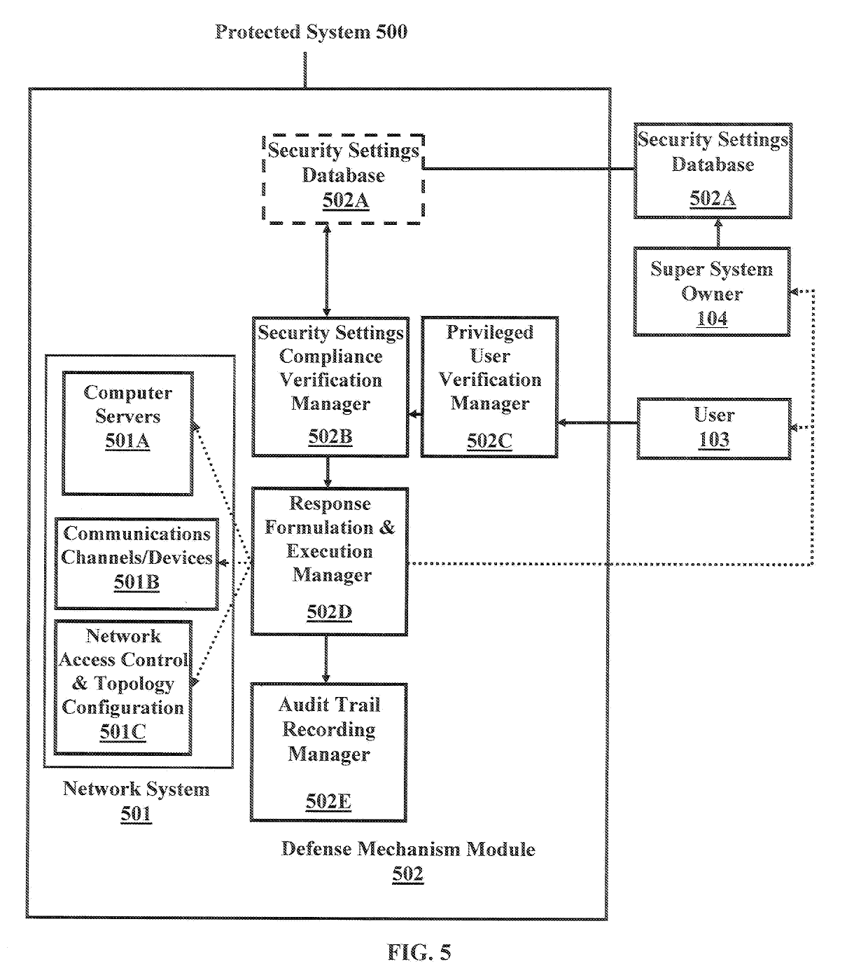

FIG. 5 illustrates a system for managing insider security threats in a network environment, according to the other embodiment of the invention. A protected system 500 can comprise a network system 501, and a defense mechanism module 502 that can be totally integrated into the core components of network system 501.

Network system 501 can comprise computer servers 501A, communication channels and devices 501B, and network access control and topology configuration devices 501C, or any combination thereof. Computer servers 500A can include all servers connected to the network such as file servers, proxy servers, print servers, database servers, mail servers, web servers, or any combination thereof. Communication channels and devices 501B can include bridges, routers, repeaters, modems, filters, firewalls, switches, or gateways, or any combination thereof. Network access control and topology configuration 501C can include information such as network Access Control Lists (ACLs) that can be used to limit host access based on source address rule by preventing the use of a fake source address when connecting to the network, and/or network topologies that should be protected from being changed by a network administrator.

Defense mechanism module 502 can comprise a security settings database 502A, a security settings compliance verification manager 502B, a privileged user verification manager 502C, response formulation and execution manager 502D, and an audit trail recording manager 502E. The security settings database 502A may or may not reside inside protected system 500; thus it can be depicted as a dotted box inside protected system 500 in FIG. 5. The security settings can be parameters that have been entered into security settings database 502A by SSO 104 to support certain business objectives and comply with certain security guidelines, such as, but not limited to Federal Information Systems Management Act (FISMA) of 2002, OMB Circular A-123, NIST Special Publications (such as SP 800-53), and others. The parameter settings as recommended by these organizations can be for the most part static, meaning that they rarely have to be changed. Security settings database 502A can store approved security settings that can be created, maintained, and collectively owned by SSO 104. Security settings compliance verification manager 502B can consult with security settings database 502A to determine whether a request complies with the approved security settings. Security settings compliance verification manager 502B can consult with security settings database 502A to determine whether a request from a system administrator complies with the approved security settings. Privileged user verification manager 502C can determine whether the request was made from a privileged user. Response formulation and execution manager 502D can formulate the appropriate response based on the outcome of the consultation with the security settings database 502A and is able to execute the response in order to protect protected system 500. Audit trail recording manager 502E can record all requests submitted to the system and the response by the system to each request. This information can be used as actionable information by protected system 500, more specifically by its defense mechanism components, to respond to future requests and to discover patterns related to requests by insiders.

An example of a network embodiment follows. A network administrator wants to allow certain client software installed on a server to communicate with another server connected to the network. The client software communication with the other servers on the network can go through a firewall and specifically through a port within the firewall. A certain port identified by a port number can be opened for the communication to be established. Generally, the network administrator has the power to open any port on the firewall to allow communication. The defense mechanism module 502 in FIG. 5 can be used if the network administrator tries to open certain port number on the firewall to allow certain software to be installed on a server.

An example operation will be described by way of the flow chart in FIG. 3. Suppose that a network administrator issues a request to allow certain client software to be installed on a server. The request can be determined to come from a privileged user because the network administrator can be one of privileged users (action 302). Security settings compliance verification manager 502B can determine whether the request is allowed by consulting with security settings database 502A, which can store a list of all software allowed to be installed on the server (action 303). If the request complies with the approved security settings as reflected by the security settings database 502A, the request can be processed (action 304), the privileged user can be notified (action 305), and audit trail can be updated by audit trail recording manager 502E (action 306). If the request does not comply with the approved security settings as reflected by the security settings database 502A, the request can be rejected (action 307), the privileged user can be notified (action 308), and SSO 104 can be alerted (action 309). The security settings verification manager 502B can also determine whether SSO 104 overrides and thus approves the request. If SSO 104 chooses to allow the operation (action 310) by modifying the security settings, then the request can be processed (action 311) and the audit trail can be updated by audit trail recording manager 502E (action 313). Otherwise, the privileged user can be notified (action 312), and the audit trail can be updated by audit trail recording manager 502E (action 313).

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described example embodiments. For example, one skilled in the art will recognize that embodiments of the invention could be an operating system environment, network environment, application environment, and any combination of those environments. In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

It should also be understood that the terms “a”, “an”, “the”, “said”, etc., should be interpreted as “at least one”, “the at least one”, etc. in the application (e.g., specification, claims, figures, etc.).

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A system protection method, comprising:
determining, by a privileged user verification manager, whether a request is made from a privileged user;
determining, by a security settings compliance verification manager, whether the request is allowable in a system based on approved security settings utilizing a defense mechanism module including the privileged user verification manager and the security settings compliance verification manager such that all communications between the privileged user and the system first communicate with the defense mechanism module; and
enabling, by a response formulation and execution manager, the request to be processed in the system when the request is allowable.

2. The method of claim 1, wherein the system is a database, application, operating system, or network, or any combination thereof.

3. The method of claim 1, wherein the privileged user is a database administrator, system administrator, or network administrator, or any combination thereof.

4. The method of claim 1, further comprising:
alerting, by the response formulation and execution manager, a Super System Owner (SSO) comprising at least two individuals and/or at least two entities when the request is allowable.

5. The method of claim 1, further comprising:
notifying the privileged user by the response formulation and execution manger and recording an audit trail by the audit trail recording manager when the request is not allowable.

6. The method of claim 1, further comprising:
notifying the privileged user by the response and execution manager and recording an audit trail by the audit trail recording manager when the request is allowable.

7. A system protection method, comprising:
determining, by a privileged user verification manager, whether a request is made from a privileged user;
determining, by a security settings compliance verification manager, whether the request is allowable in a system based on approved security settings, the approved security settings being modifiable by a SSO; and
enabling, by a response formulation and execution manager, the request to be processed in the system when the request is allowable.

8. The method of claim 7, wherein the SSO comprises at least two individuals and/or at least two entities.

9. The method of claim 7, wherein each SSO owns a partial password such that only when partial passwords are concatenated do the partial passwords constitute a valid password to modify the approved security settings.

10. The method of claim 7, wherein the system is a database, application, operating system, or network, or any combination thereof.

11. The method of claim 7, wherein the privileged user is a database administrator, system administrator, or network administrator, or any combination thereof.

12. The method of claim 7, further comprising:
alerting, by the response formulation and execution manager, the SSO when the request is not allowable.

13. The method of claim 7, further comprising:
notifying the privileged user and recording an audit trail by the response formulation and execution manager and recording an audit trail by an audit trail recording manager when the request is not allowable.

14. The method of claim 7, further comprising:
notifying the privileged user by the response formulation and execution manager and recording an audit trail by the audit trail recording manager when the request is allowable.

15. A system, comprising:
a processor configured for:
determining whether a request is made from a privileged user;
determining whether the request is allowable in a system based on approved security settings utilizing a defense mechanism module such that all communications between the privileged user and the system first communicate with the defense mechanism module; and
enabling the request to be processed in the system when the request is allowable.

16. The system of claim 15, wherein the system is a database, application, operating system, or network, or any combination thereof.

17. The system of claim 15, wherein the privileged user is a database administrator, system administrator, or network administrator, or any combination thereof.

18. The system of claim 15, wherein the processor is further configured for:
alerting a Super System Owner (SSO) comprising at least two individuals and/or at least two entities when the request is allowable.

19. The system of claim 15, wherein the processor is further configured for:
notifying the privileged user and recording an audit trail when the request is not allowable.

20. The system of claim 15, wherein the processor is further configured for:
notifying the privileged user and recording an audit trail when the request is allowable.
